(19) United States
(12) Patent Application Publication
(10) Pub. No.: US 2002/0090250 A1
(43) Pub. Date: Jul. 11, 2002

(54) Device for tooth brushing

(76) Inventor: Max Blecher, Brooklyn, NY (US)

Correspondence Address: Ilya Zborovsky, 6 Schoolhouse Way, Dix Hills, NY, 11746, US

(21) Appl. No.: 10/053,640

(22) Filed: Jan. 24, 2002

Related U.S. Application Data
(60) Provisional application No. 60/260,847, filed on Jan. 10, 2001.

(51) Int. Cl. B43K 5/06

(52) U.S. Cl. 401/175; 401/123

(57) ABSTRACT

A device for tooth brushing has a main element, a tooth brushing element having a supporting member provided with a plurality of brushes and connected to the main element, and a tooth paste container removably connected with the main element at a side which is opposite to a side of the tooth brushing element, so that the tooth paste container can be removed from the main element, paste can be squeezed from the tooth paste container onto the bristles, and a user can brush teeth by holding the main element with or without the tooth paste container attached.

### BACKGROUND OF THE INVENTION

The present invention relates to devices for tooth brushing.

Devices for tooth brushing are known in the art. The known tooth brushing devices include a tooth brush having a supporting part and a plurality of bristles arranged on a portion of said supporting part. Such tooth brushing devices are known as simple manual operated tooth brushes, power-operated tooth brushes, etc. It is believed that the existing devices for tooth brushing can be further improved.

### SUMMARY OF THE INVENTION

Accordingly, it is an object of the present invention to provide a device for tooth brushing which is a further improvement of the existing devices.

In keeping with these objects and with others which will become apparent hereinafter, one feature of the present invention resides, briefly stated, in a device for tooth brushing which includes a supporting element; a plurality of bristles provided on said supporting element; and a tooth paste container removably connected with said supporting element.

When the device for tooth brushing is designed in accordance with the present invention, the tooth paste container can be removed from the supporting element, the tooth paste can be squeezed from the tooth paste container onto the bristles, and a tooth brushing can be performed either with the supporting element held by the user without the tooth paste container or with the tooth paste container attached back to the supporting element.

The novel features which are considered as characteristic for the present invention are set forth in particular in the appended claims. The invention itself however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a side view of a device for tooth brushing in accordance with the present invention, with a soft tooth paste container;

FIG. 2 is a side view of the device for tooth brushing in accordance with the present invention, with an unscrewed lid;

FIG. 3 is a longitudinal section through the device for tooth brushing of FIG. 1 on a somewhat larger scale;

FIG. 4 is a view showing a device for tooth brushing in accordance with the present invention with a plunger type tooth paste container;

FIG. 5 is a side view of the device for tooth brushing in accordance with the present invention having a pencil case with a clip and pads inside;

FIG. 6 is a side view with a partial longitudinal section of a simpler version of the device for tooth brushing in accordance with the present invention;

FIGS. 7a, 7b, 7c are views showing cross-sections of a tooth paste container of the inventive device for tooth brushing, and

FIG. 8 is a perspective view of a tooth paste container of the inventive device for tooth brushing.

### DESCRIPTION OF THE PREFERRED EMBODIMENTS

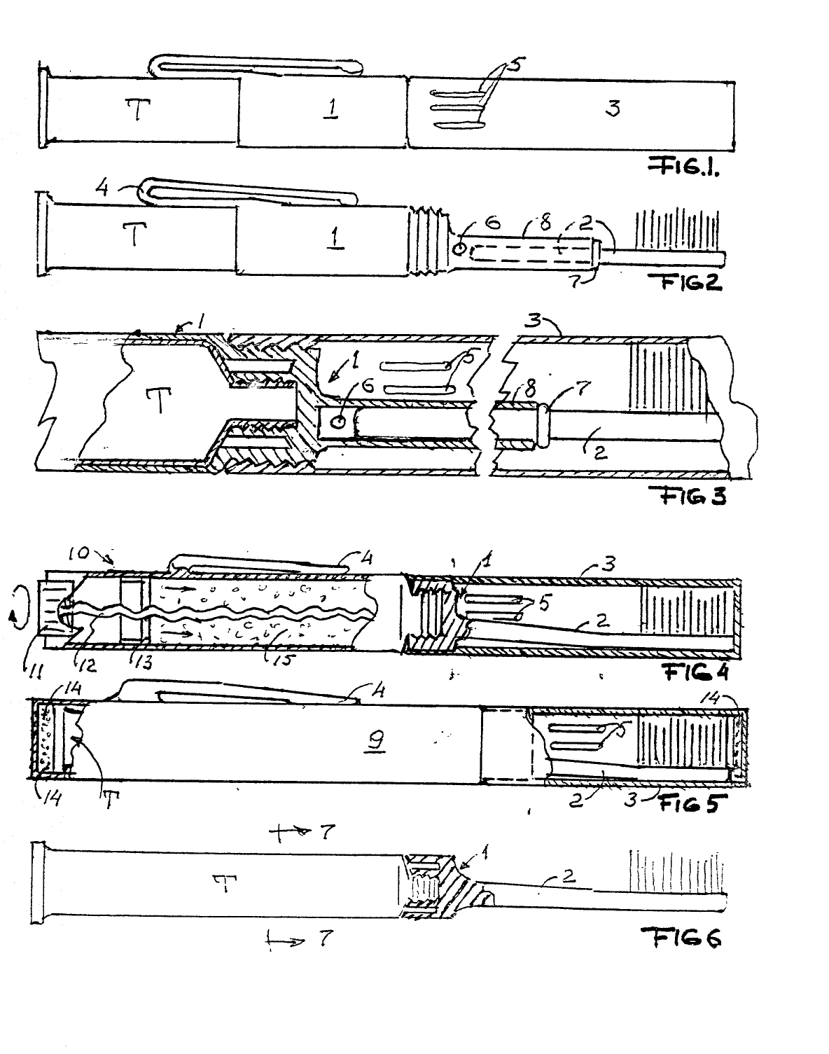

The device for tooth brushing in accordance with the present invention is shown in FIGS. 1, 2 and 3 has a main element which is a supporting element which is identified as a whole with reference numeral 1. A tooth brushing element a supporting member identified with reference numeral 2 and provided on one end with a plurality of bristles. The other end of the supporting element 2 is inserted into the main element 1 for example with a tight fit, so that its projection 7 abuts against an end face of a hollow housing 8 of the main element 1. Openings 5 and 6 are provided for evaporation of moisture, air circulation and to facilitate insertion of the supporting element 2. A clip 4 is attached to the main element 1 in the embodiment shown in FIGS. 1, 2, 3.

As can be seen from the drawings, the opposite end of the main element 1 is connected with a tooth paste container or tube which is identified as T. The connection can be performed for example by interengaging threads provided on a neck of the tooth paste container T and in an inner hole of the opposite end of the main element 1.

A lid 3 is further provided to cover the tooth brushing element with its supporting member 2 and the bristles. The lid 3 is substantially tubular and is also connected with the main element 1, for example by interengaging threads.

The device for tooth brushing in accordance with the present invention shown in FIGS. 1-3 in the position non use in order to use the device, the lid 3 is unscrewed from the main element 1, the tooth paste container T is also unscrewed from the main element 1, a tooth paste is squeezed out of the tooth paste container T onto the bristles and a user uses the main element to brush the teeth either alone, or being screwed again back with the tooth paste container T.

FIG. 4 shows a further embodiment of the present invention. Here the tooth paste container 10 is not of a squeezer type, but instead of a piston type. It has a nut 11 which turns a screw 12, so that a piston 13 translatorily moves along the screw 12 and Squeezes the tooth paste 15 out of the container onto the bristles wren needed. In this embodiment the clip 4 is arranged on the tooth paste container.

The device for tooth brushing in accordance with the present invention shown in FIG. 5 has a pencil case 9 provided with a clip 4, and pads 14 arranged at both sides of the device, in particular at one end of the lid 3, and at one end of the tooth paste container T.

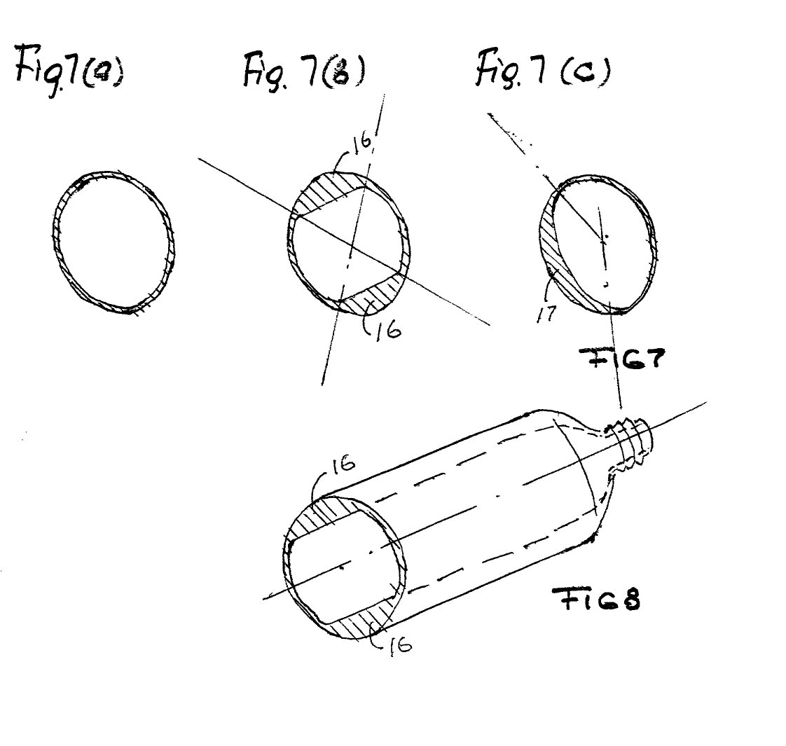

FIG. 6 shows a simplified version of the inventive device. The device for tooth brushing in accordance with this embodiment of the present invention has a tooth paste container T which is screwed with tooth brushing element itself, in particular to its supporting member 2 provided with a plurality of bristles on its end.

As can be seen from FIG. 7a, 7b, 7c, the tooth paste container can have a cylindrical wall which either has a uniform thickness over its periphery as shown in FIG. 7a, or thickened portions provided at least in two regions of the periphery as shown in FIG. 7b, or at least in one thickened portion provided at least in one part of its periphery as shown in FIG. 7c. The thickened portions 16 of FIG. 7b are also shown in a perspective view of FIG. 8, while the thickened portion of FIG. 7 is identified with reference numeral 17.

It is believed to be clear that in the embodiment shown in FIGS. 1, 2, and 3 the main element 1 is preferably rigid and holds the clip 4 to be attached for example to a user's clothes for transportation or the like, while in the embodiment of FIGS. 4, 5, 6 the clip 4 is provided on the tooth paste container which for said purpose can be made more rigid.

It will be understood that each of the elements described above, or two or more together, may also find a useful application in other types of constructions differing from the types described above

While the invention has been illustrated and described as embodied in device for tooth brushing, it is not intended to be limited to the details shown since various modifications and structural charges may be made without departing in any way from the spirit of the present invention.

Without further analysis, the foregoing will so fully reveal the gist of the present invention that others can, by applying current knowledge, readily adapt it for various applications without omitting features that, from the standpoint of prior arts fairy constitute essential characteristics of the generic or specific aspects of this invention.

What is claimed as new and desired to be protected by Letters Patent is set forth in the appended claims:

1. A device for tooth brushing, comprising a main element; a tooth brushing element having a supporting member provided with a plurality of brushes and connected to said main element; and a tooth paste container removably connected with said main element at a side which is opposite to a side of said tooth brushing element, so that said tooth paste container can be removed from said main element, paste can be squeezed from said tooth paste container onto said bristles, and a user can brush teeth by holding said main element with or without said tooth paste container attached.

2. A device as defined in claim 1, wherein said main element is formed of one piece with said tooth brushing element.

3. A device as defined in claim 1, wherein said main element is removably connected with said tooth brushing element.

4. A device as defined in claim 1; and further comprising a case which surrounds at least said tooth brushing element in a storage position and is removable for using said tooth brushing element for brushing teeth.

5. A device as defined in claim 1, wherein said tooth brushing container is of a squeezing type so that by squeezing of said tooth brushing container the paste can be squeezed out of said tooth brushing container.

6. A device as defined in claim 1, wherein said tooth brushing container is of a piston type, and has a piston with which the paste can be squeezed out of said tooth brushing container.

7. A device as defined in claim 1; and further comprising a clip for holding the device for tooth brushing in a clipped position.

8. A device as defined in claim 7, wherein said clip is provided on said main element.

9. A device as defined in claim 7, wherein said clip is provided on said tooth paste container.

10. A device as defined in claim 1; and further comprising means for connecting said main element with said tooth brushing container and including thread means.

11. A device as defined in claim 1; and further comprising means for connecting said main element with said tooth brushing element and means for connecting said main element with said tooth brush container, both said connecting means being formed as thread means.
